(19) United States
(12) Patent Application Publication
(10) Pub. No.: US 2020/0070269 A1
(43) Pub. Date: Mar. 5, 2020

(54) LASER-INDUCED ANTI-CORROSION MICRO-ANCHOR STRUCTURAL LAYER FOR METAL-POLYMERIC COMPOSITE JOINT AND METHODS OF MANUFACTURING THEREOF

(71) Applicant: GM GLOBAL TECHNOLOGY OPERATIONS LLC, Detroit, MI (US)

(72) Inventors: Hongliang WANG, Sterling Heights, MI (US); Xingcheng XIAO, Troy, MI (US); Guoxian XIAO, Troy, MI (US); Hua-Tzu FAN, Troy, MI (US); Jorge F. ARINEZ, Rochester Hills, MI (US)

(73) Assignee: GM GLOBAL TECHNOLOGY OPERATIONS LLC, Detroit, MI (US)

(21) Appl. No.: 16/117,265

(22) Filed: Aug. 30, 2018

(51) Int. Cl. B23K 1/005; B23K 35/30; B23K 26/364

(52) U.S. Cl. CPC B23K 1/0056; B23K 2103/04; B23K 26/364; B23K 35/3053

(57) ABSTRACT

A method of forming a layer on a first component according to various aspects of the present disclosure includes melting a portion of a first metallic composition of the first component. The melting includes directing a laser beam toward a first surface of the first component. The method further includes depositing a second metallic composition on the first surface by directing a precursor including the second metallic composition toward an intersection of the first surface and the laser beam. The second metallic composition is galvanically more noble than the first metallic composition. The method further includes forming the layer on the first component by solidifying the first metallic composition and the second metallic composition. The first component is configured to be joined to a second component by engaging a plurality of micro-anchors defined on the layer with a polymer of the second component.

### INTRODUCTION

This section provides background information related to the present disclosure which is not necessarily prior art.

The present disclosure pertains to a metal-polymeric composite joint and methods of manufacturing the metal-polymeric composite joint. More specifically, the metal-polymeric composite joint may include a laser-induced micro-anchor structural layer.

Weight reduction for increased fuel economy in vehicles has spurred the use of various lightweight materials, such as aluminum and magnesium alloys as well as use of light-weight reinforced composite materials. While use of such lightweight materials can serve to reduce overall weight and generally improve fuel efficiency, issues can arise in manufacturing certain components. For example, molding large, complex parts from a reinforced composite material may be difficult or infeasible. It may therefore be desirable to join multiple smaller components. However, joining dissimilar materials, such as a metal and a reinforced polymeric composite, may present additional challenges such as low initial strength, susceptibility to corrosion, and long cycle times in manufacturing. Accordingly, it would be desirable to develop a quick and robust method of joining metal and composite components that form corrosion-resistant high-strength joints.

### SUMMARY

This section provides a general summary of the disclosure, and is not a comprehensive disclosure of its full scope or all of its features.

In various aspects, the present disclosure provides a method of forming a layer on a first component. The method includes melting a portion of a first metallic composition of the first component by directing a laser beam toward a first surface of the first component. The method further includes depositing a second metallic composition on the first surface by directing a precursor including the second metallic composition toward an intersection of the first surface and the laser beam. The second metallic composition is galvanically more noble than the first metallic composition. The method further includes forming the layer on the first component by solidifying the first metallic composition and the second metallic composition. The first component is configured to be joined to a second component by engaging a plurality of micro-anchors defined on the layer with a polymer of the second component.

In one aspect, the first metallic composition includes a steel. The second metallic composition includes a stainless steel.

In one aspect, the layer defines a thickness of greater than or equal to about 10 μm.

In one aspect, the precursor includes a plurality of particles. At least a portion of the particles of the plurality of particles include the second metallic composition.

In one aspect, the laser beam is a continuous wave (CW) laser beam.

In one aspect, the laser beam has a power of greater than or equal to about 500 W to less than or equal to about 3,000 W. The laser beam has a travel speed of greater than or equal to about 5 mm/s to less than or equal to about 80 mm/s. The laser beam has a beam size of greater than or equal to about 1 mm to less than or equal to about 10 mm.

In one aspect, the method further includes forming a plurality of micro-anchors on a second surface of the layer by directing a nanosecond pulsed laser beam toward the second surface.

In one aspect, the method further includes removing at least a portion of a coating of the first component prior to the melting. The coating includes zinc.

In one aspect, the removing includes directing a nanosecond pulsed laser beam toward the first surface of the first component.

In one aspect, the method further includes forming a depression in the first surface of the first component prior to the melting. The melting includes directing the first laser beam toward the depression. The depositing includes directing the precursor toward the depression.

In various aspects, the present disclosure provides a method of forming a metal-polymeric composite joint. The method includes disposing a first component on a second component. The first component includes a layer The first component includes a body. The body has a first surface. The layer is disposed across at least a portion of the first surface. The layer includes a second surface. The second surface of the layer engages a third surface of the second component. The body includes a first metallic composition. The layer includes a second metallic composition. The second component includes a polymer and a plurality of reinforcing fibers. The method further includes melting at least a portion of the polymer by directing a heat source toward a fourth surface of the first component. The fourth surface is disposed opposite the second surface of the layer. The method further includes forming the metal-polymeric composite joint by solidifying the polymer.

In one aspect, the heat source includes a continuous wave (CW) laser beam.

In one aspect, the method further includes applying a dielectric coating to the first component and the second component after the forming.

In one aspect, the first metallic composition includes a steel. The second metallic composition includes a stainless steel.

In one aspect, the method further includes forming a plurality of micro-anchors on a second surface of the layer by directing a nanosecond pulsed laser beam toward the second surface.

In one aspect, the plurality of reinforcing fibers include carbon. The polymer is selected from the group consisting of: a polycarbonate (PC), a high-density polyethylene (HDPE), polyoxymethylene (POM), a thermoplastic elastomer (TPE), acrylonitrile butadiene styrene (ABS), a thermoplastic olefin (TPO), a polyamide (PA, nylon), and combinations thereof.

In various aspects, the present disclosure provides a metal-polymeric composite joint. The metal-polymeric composite joint includes a first component and a second component. The first component includes a body and a layer. The body has a first surface. The body includes a first metallic composition. The layer is on at least a portion of the first surface. The layer has a second surface. The layer includes a second metallic composition. The second metallic composition is galvanically more noble than the first metallic composition. The second component is coupled to the first component. The second component has a third surface. The third surface engages the second surface of the layer of the first component. The second component includes a polymer and a plurality of carbon fibers. The metal-polymeric composite joint has a lap shear strength of greater than or equal to about 6 kN after 5 years.

In one aspect, the first metallic composition includes a steel. The second metallic composition includes a stainless steel.

In one aspect, the layer defines a thickness of greater than or equal to about 10 μm.

In one aspect, the second surface includes a plurality of micro-anchors. A portion of the polymer engages at least a portion of the micro-anchors.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1D show a metal-polymeric composite assembly according to certain aspects of the present disclosure; FIG. 1A is a sectional view of the metal-polymeric composite assembly; FIG. 1B is a top view of the metal-polymeric composite assembly; FIG. 1C is a side view of the metal-polymeric assembly; and FIG. 1D is a top view of a layer of a metal component of the metal-polymeric composite assembly;

FIGS. 2A-2B show a surface of the layer of FIG. 1D; FIG. 2A is a partial perspective side view of the layer; and FIG. 2B is a partial perspective view of a micro-aperture of the surface;

FIG. 3 is a partial sectional view of another metal-polymeric composite assembly according to certain aspects of the present disclosure;

FIG. 4 is a sectional view of yet another metal-polymeric composite assembly according to certain aspects of the present disclosure;

FIG. 5 is a flowchart depicting an example method of forming a metal-polymeric composite assembly according to certain aspects of the present disclosure;

FIG. 6 is a schematic view of a sacrificial coating layer removal process according to certain aspects of the present disclosure;

FIG. 7 is a top view of a metal component having a portion of the sacrificial coating layer removed by the process of FIG. 6;

FIG. 8 is a schematic view of a laser cladding process according to certain aspects of the present disclosure;

FIGS. 9A-9B show a metal component having a layer formed by the laser cladding process of FIG. 8; FIG. 9A is a top view of the metal component; and FIG. 9B is a scanning electron microscopy (“SEM”) image of the layer;

FIGS. 10A-10B relate to a process of laser-treating a surface of a metal component according to certain aspects of the present disclosure; FIG. 10A is a schematic view of the laser surface treatment process; and FIG. 10B is a top view of the metal component showing a laser pattern;

FIGS. 11A-11B show SEM images of a surface formed by the method of FIGS. 10A-10B;

FIG. 12 is a top view of another laser pattern for a laser surface treatment according to certain aspects of the present disclosure;

FIGS. 13A-13B relate to a process of laser-joining a metal component to a polymeric component; FIG. 13A is a schematic view of the laser-joining process; and FIG. 13B is a bottom view of the metal component showing a laser pattern;

FIGS. 14A-14B are SEM images of a metal-polymeric composite joint according to certain aspects of the present disclosure;

FIG. 15 shows a top view of a metal component having another laser pattern according to certain aspects of the present disclosure;

FIGS. 16A-16B show yet another laser pattern according to certain aspects of the present disclosure; FIG. 16A is a top view of a metal component; and FIG. 16B is sectional view of the metal component taken at line 16B-16B of FIG. 16A;

FIG. 17 is a graphical representation of initial lap shear strength and lap shear strength after 7-day corrosion testing for a first sample including laser-cladded steel at 0 days, a second including non-laser-cladded steel at 0 days, a third sample including laser-cladded steel at 7 days, and a fourth sample including non-laser-cladded steel at 7-days;

FIGS. 18A-18B show the first sample after lap shear testing at day 0; FIG. 18A is a bottom view of the first sample; and FIG. 18B is a top view of the first sample;

FIGS. 19A-19B show the third sample after lap sheer testing at day 7; FIG. 19A is a bottom view of the third sample; and FIG. 19B is a top view of the third sample;

FIG. 20 is a graphical representation of lap shear strength after cyclic corrosion testing for joints including laser-cladded steel and joints including non-laser-cladded steel; and

FIGS. 21A-21C relate to analysis of the first sample of FIGS. 18A-18B taken at line 21A-21A of FIG. 18B; FIG. 21A is an SEM image of a joint of the first sample; FIG. 21B is an energy-dispersive X-ray spectroscopy (EDX) image of the joint; and FIG. 21C is a legend correlating color to composition for the image of FIG. 21B.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Joints of metal-polymeric composite assemblies may be particularly prone to corrosion at an interface between a metal component and a polymeric composite component when the polymeric composite component includes a conductive material, such as carbon fiber. Because carbon is very inert or noble when compared to certain metals, such as steel, the metal component that is electrically connected to the carbon fiber composite may be prone to galvanic corrosion, leading to a degradation in joint strength over time.

In various aspects, the present disclosure provides a metal-polymeric composite joint that is corrosion resistant and has a high initial lap shear strength. The joint may include a metal component including a first metallic composition; a composite component including a polymer and a plurality of reinforcing fibers, such as carbon fibers; and a layer of a second metallic composition disposed on the first metallic material and interfacing with the composite component. The second metallic composition may be galvanically more noble than the first metallic composition so that the interface or joint is last to corrode. In certain aspects, the first metallic component is steel and the second metallic component is stainless steel. The joint may have a high initial lap shear strength, such as greater than or equal to about 10,000 N. The joint may be resistant to corrosion, having a lap shear strength of greater than or equal to about 7,000 N after five years and greater than or equal to about 5,500 N after ten years.

### Metal-Polymeric Composite Assembly

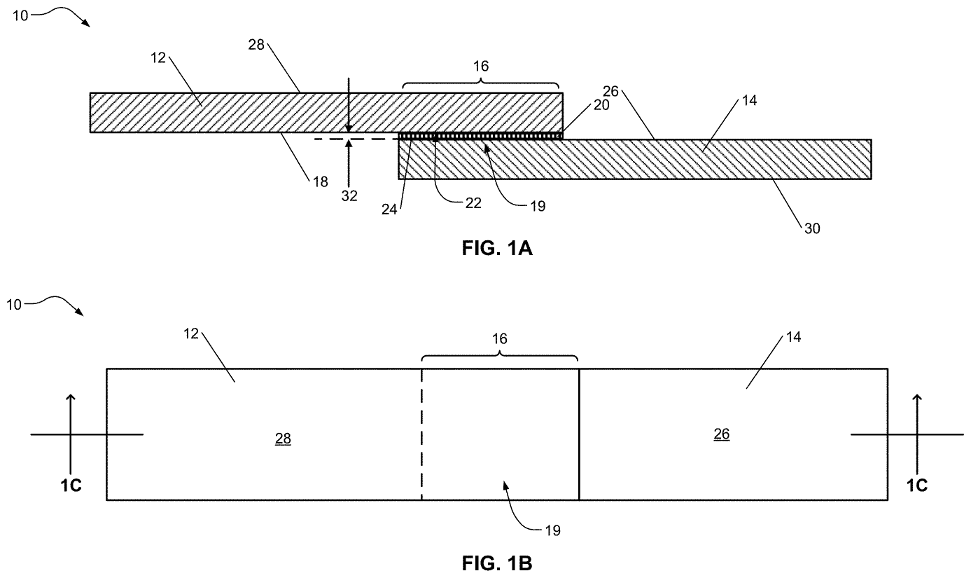

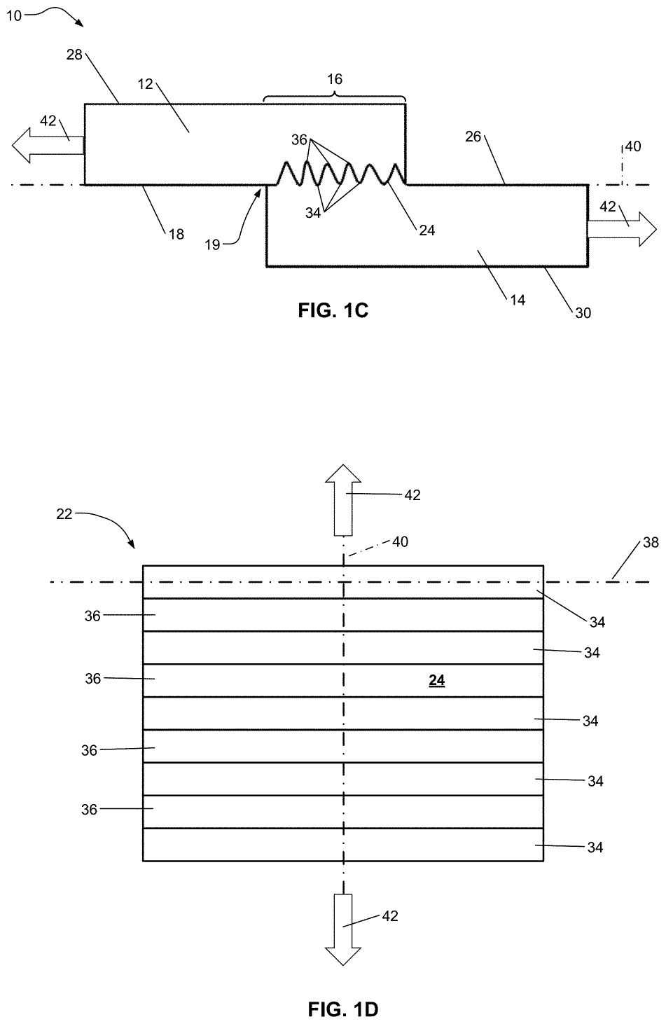

Referring to FIGS. 1A-1D, a metal-polymeric composite assembly 10 according to certain aspects of the present disclosure is provided. The metal-polymeric composite assembly 10 may include a first or metal component 12 coupled to a second or composite component 14. The composite component 14 may include a polymer and a plurality of reinforcing fibers, as will be discussed in greater detail below. The metal component 12 and the composite component 14 are coupled to one another at a joining region 16 to form a metal-polymeric composite joint 19.

The metal component 12 may include a first surface 18 that faces the composite component 14. The metal component 12 may further include a layer 20 that is disposed on at least a portion 22 of the first surface 18. The layer 20 may include a second surface 24 that engages a third surface 26 of the composite component 14. The metal component 12 may further include a fourth surface 28. The fourth surface 28 may be disposed opposite the first surface 18. The composite component 14 may further include a fifth surface 30. The fifth surface 30 may be disposed opposite the third surface 26.

The metal component 12 may include a first metallic composition. The layer 20 may include a second metallic composition. As discussed above, metal-polymeric composite joints may be susceptible to galvanic corrosion. The second metallic composition may be galvanically more noble than the first metallic composition. Thus, the joining region 16 may be the last portion of the metal-polymeric composite assembly 10 to corrode.

The first metallic composition may include a steel. In various aspects, the first metallic composition may include low carbon steel or high strength steel. The second metallic composition may include a stainless steel. In various aspects, the stainless steel includes stainless steel 318, stainless steel duplex, or stainless steel 304. In various aspects, the second metallic composition may include other metals such as platinum, gold, titanium, silver, silicon bronze, chromium, nickel alloys (e.g., nickel copper, nickel silver), and combinations thereof.

As discussed above, the composite component 14 may include the polymer and the plurality of reinforcing fibers. The polymer may be selected from the group consisting of: a polycarbonate (PC), a high-density polyethylene (HDPE), polyoxymethylene (POM), a thermoplastic elastomer (TPE), acrylonitrile butadiene styrene (ABS), a thermoplastic olefin (TPO), a polyamide (PA, nylon), and combinations thereof. The plurality of reinforcing fibers may include carbon fibers, glass fibers, or combinations thereof, by way of example. In various aspects, a carbon fiber may include a powdered fiber, a short fiber, a long fiber, a continuous fiber, or combinations thereof.

The layer 20 may have a thickness 32 (FIG. 1A) in a direction substantially perpendicular to the first surface 18. In various aspects, the thickness may be greater than or equal to 10 μm, optionally greater than or equal to about 20 μm, optionally greater than or equal to about 30 μm, optionally greater than or equal to about 40 μm, optionally greater than or equal to about 50 μm, optionally greater than or equal to about 60 μm, optionally greater than or equal to about 70 μm, optionally greater than or equal to about 80 μm, optionally greater than or equal to about 90 μm, optionally greater than or equal to about 100 μm, optionally greater than or equal to about 150 μm, optionally greater than or equal to about 200 μm, optionally greater than or equal to about 300 μm, optionally greater than or equal to about 400 μm, optionally greater than or equal to about 500 μm, and optionally greater than or equal to about 600 μm.

As best shown in FIG. 1C, at least a portion of the second surface 24 of the layer 20 of the metal component 12 may include a plurality of elongate peaks 34 and a plurality of elongate valleys 36. The elongate peaks 34 and the elongate valleys 36 may be present on the second surface 24 in the joining region 16. The plurality of elongate valleys 36 may be disposed between the plurality of elongate peaks 34 so that the elongate peaks 34 and the elongate valleys 36 alternate with one another in the joining region 16.

As shown in FIG. 1D, each elongate peak 34 may be disposed substantially parallel to each other elongate peak 34. Similarly, each elongate valley 36 may be disposed substantially parallel to each other elongate valley 36. The elongate valleys 36 may be substantially evenly disposed within the joining region 16. However, in alternative aspects, the elongate valleys 36 may be unevenly spaced. For example, the elongate valleys 36 may be disposed in smaller subgroups (e.g., subgroups of five elongate valleys 36 in close proximity spaced apart from other subgroups) (not shown).

The elongate peaks 34 and the elongate valleys 36 may extend substantially parallel to a first axis 38. A second axis 40 may extend substantially perpendicular to the first axis 38. The second axis 40 may correspond to a direction of applied force, as indicated by the arrows 42. The arrangement of the elongate peaks 34 and elongate valleys 36 may result in the joint 19 having a lap shear strength that is greatest along the second axis 40 because of mechanical interaction of the elongate peaks 34 and elongate valleys 36 of the second surface 24 with the third surface 26 as the force 42 is applied.

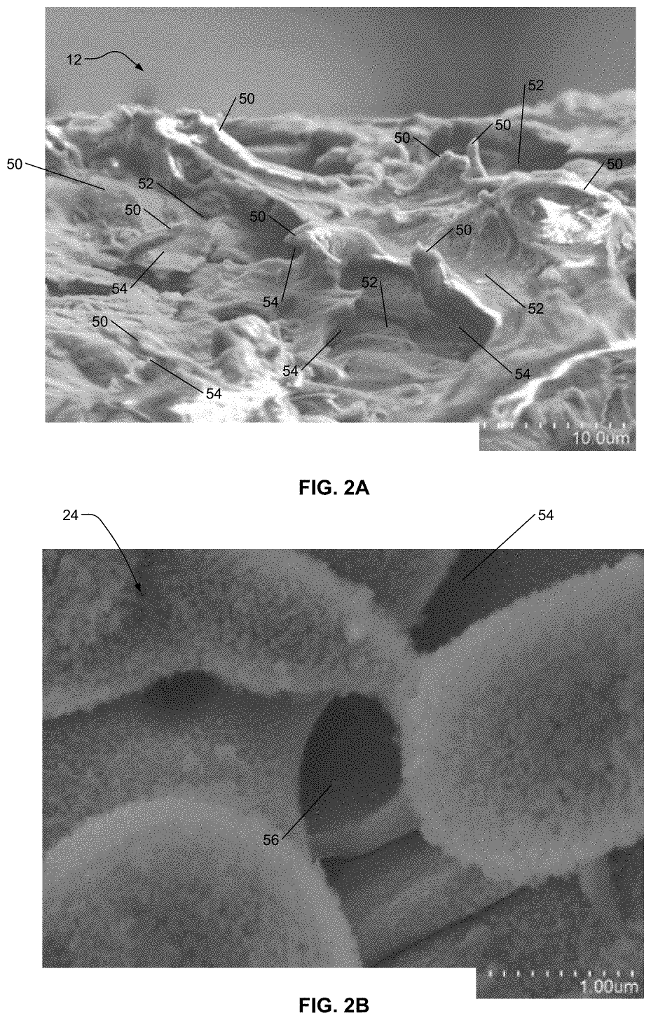

With reference to FIGS. 2A-2B, the second surface 24 of the layer 20 of the metal component 12 is shown. The second surface 24 includes a plurality of crests 50 and a plurality of troughs 52. At least at least a portion of the crests 50 and at least a portion of the troughs 52 may be defined on each elongate peak 34. At least a portion of the crests 50 and at least a portion of the troughs 52 may be defined on each elongate valley 36. A pattern of crests 50 and troughs 52 may be irregular. Dimensions of the crests 50 and elongate troughs 52 may also be irregular. For example, crests 50 may differ from one another in size and shape. Troughs 52 may similarly differ from one another in size and shape.

An average roughness of the second surface 24 may be greater than or equal to about 5 μm and less than or equal to about 100 μm, optionally greater than or equal to about 20 μm to less than or equal to about 80 μm, and optionally greater than or equal to about 30 μm to less than or equal to about 60 μm.

At least a portion of the crests 50 may also include a plurality of micro-anchors 54. The micro-anchors 54 may include invaginations, cavities, pores, hooks, and/or undercut regions that are formed during the cooling process. The micro-anchors 54 may include extensions that are at an angle to another portion of the second surface 24 so as to form undercuts or protrusions that serve as anchoring regions for the polymer of the composite component 14 (as compared to merely creating surface roughness/asperities formed by typical roughening techniques).

A portion of the micro-anchors 54 may be micro-apertures or micro-openings 56 having perimeters defining connected shapes, as best shown in FIG. 2B. A micro-aperture 56 is formed when solid material (i.e., the second metallic composition) extends around an entire perimeter of the micro-aperture 56. Thus, a perimeter of the micro-aperture 56 may be substantially free of gaps. The micro-anchors 54 may be irregular in size, shape, and distribution. In certain variations, the micro-anchors 54 may overlap one another.

The topography of the second surface 24, including the crests 50, the troughs 52, and the micro-anchors 54, may increase an area of the second surface 24 to facilitate intimate contact between the second surface 24 of the metal component 12 and the third surface 26 of the composite component 14. Additionally, the micro-anchors 54 may enable a strong mechanical interlock with the third surface 26. More particularly, as discussed in greater detail below, the polymer of the composite component 14 may engage the micro-anchors 54 to mechanically lock the metal component 12 to the composite component 14.

An initial lap shear strength for the joint 19 may be greater than or equal to about 6,000 N, optionally greater than or equal to about 7,000 N, optionally greater than or equal to about 8,000 N, optionally greater than or equal to about 9,000 N, optionally greater than or equal to about 10,000 N, optionally greater than or equal to about 10,500 N, and optionally greater than or equal to about 11,000 N. A lap shear strength of the joint 19 after seven days may be greater than or equal to about 5,000 N, optionally greater than or equal to about 5,500 N, optionally greater than or equal to about 6,000 N, optionally greater than or equal to about 6,100 N, optionally greater than or equal to about 6,200 N, optionally greater than or equal to about 6,300 N, and optionally greater than or equal to about 6,400 N. A lap shear strength of the joint 19 after two-and-a-half years may be greater than or equal to about 7,000 N, optionally greater than or equal to about 8,000 N, optionally greater than or equal to about 9,000 N, and optionally greater than or equal to about 10,000 N. A lap shear strength of the joint 19 after five years may be greater than or equal to about 5,500 N, optionally greater than or equal to about 6,000 N, optionally greater than or equal to about 6,500 N, and optionally greater than or equal to about 7,000 N. A lap shear strength of the joint 19 after ten years may be greater than or equal to about 4,000 N, optionally greater than or equal to about 4,500 N, optionally greater than or equal to about 5,000 N, and optionally greater than or equal to about 5,500 N.

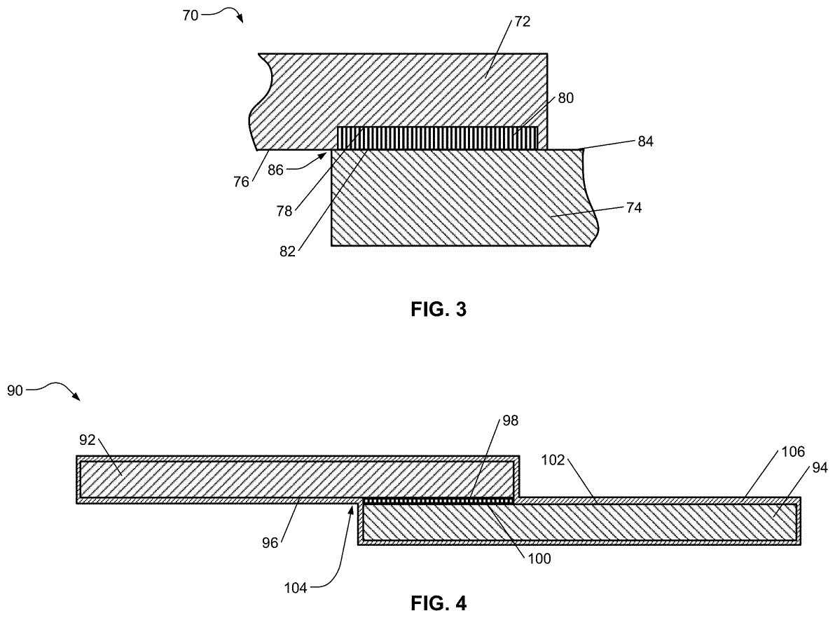

With reference to FIG. 3, another metal-polymeric composite assembly 70 according to certain aspects of the present disclosure is provided. Unless otherwise described, the assembly 70 may be similar to the assembly 10 of FIGS. 1A-2B. The assembly 70 may include a first or metal component 72 and a second or composite component 74. The first component 72 may include a first surface 76. The first surface 76 may define a depression 78. A layer 80 may be at least partially disposed within the depression 78. The layer 80 may include a second surface 82. The second surface 82 may engage a third surface 84 of the composite component 74. A height of the depression 78 may be substantially similar to a thickness of the layer 80, as shown. Thus, the first surface 76 and the second surface 82 may be substantially coplanar. However, in various alternative aspects, the thickness of the layer 80 may be greater than the height of the depression 78 (not shown).

Placement of the layer 80 within the depression 78 may facilitate increased contact between the metal component 72 and the composite component 74. More particularly, the first surface 76 of the metal component 72 and the third surface 84 of the composite component 74 may extend coplanar to one another. The increased contact between the metal component 72 and the composite component 74 may further reduce the occurrence of moisture entering the joint 86 between the metal component 72 and the composite component 74, thereby also reducing the occurrence of galvanic corrosion.

Referring to FIG. 4, yet another metal-polymeric composite assembly 90 according to certain aspects of the present disclosure is provided. Unless otherwise described, the assembly 90 may be similar to the assembly 10 of FIGS. 1A-2B. The assembly 90 may include a first or metal component 92 and a second or composite component 94. The metal component 92 may include a first surface 96. A layer 98 may be disposed on at least a portion of the first surface 96. The layer 98 may include a second surface 100. The second surface 100 of the layer 98 may engage a third surface 102 of the composite component 94 to couple the metal component 92 to the composite component 94, forming a metal-polymeric composite joint 104. A coating 106 may include the metal component 92, the composite component 94, and the layer 98. The coating 106 may include a dielectric plastic composition, such as a water-based polyurethane. In various aspects, the coating 106 includes a water-based polyurethane enamel paint. The coating 106 may fluidly seal the entire metal-polymeric composite assembly 90 to act as a barrier to moisture, thereby reducing or preventing galvanic corrosion at the joint 104.

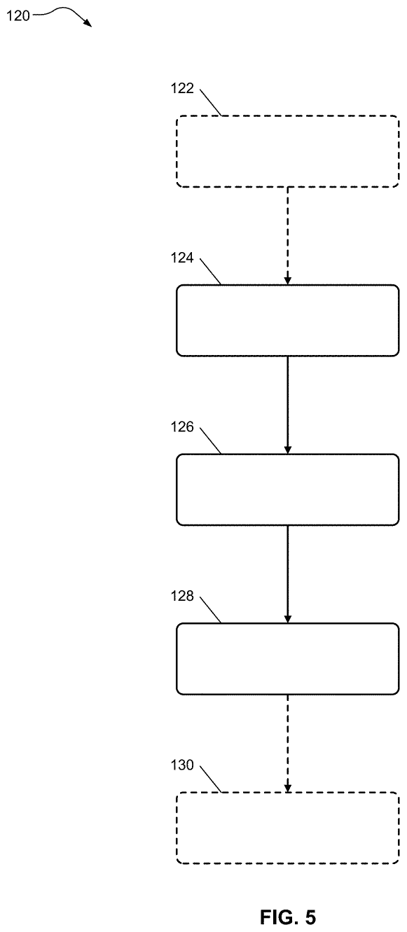

With reference to FIGS. 5-13B, a method 120 of manufacturing a metal-polymeric composite assembly according to certain aspects of the present disclosure is provided. The method is described with reference to the metal-polymeric composite assembly 10 of FIGS. 1A-2B. As shown in FIG. 5, the method 120 generally includes optionally removing a coating from the metal component 12 to expose the first metallic composition at step 122, performing laser cladding to add the layer 20 to the metal component 12 at step 124, performing a laser surface treatment to create the micro-anchors 54 on the layer 20 at step 126, laser-joining the metal component 12 to the composite component 14 at step 128, and optionally applying the coating 106 at step 130.

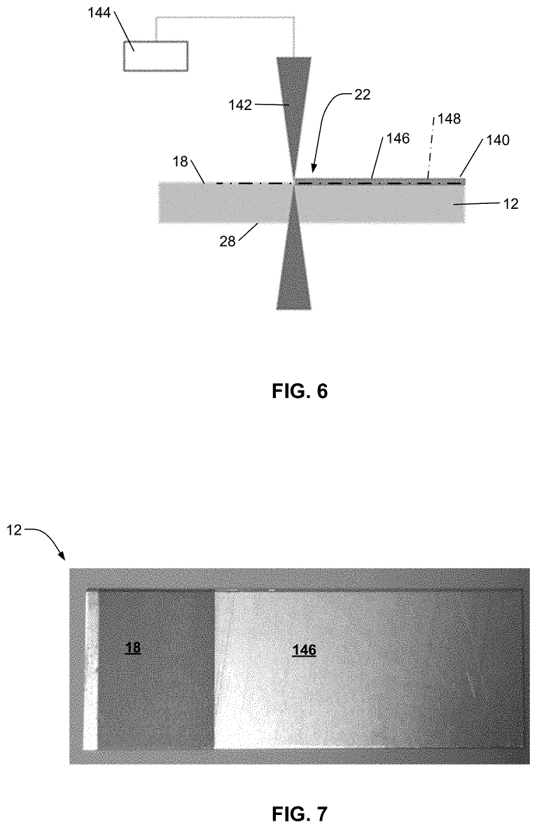

### Sacrificial Coating Removal (FIGS. 6-7)

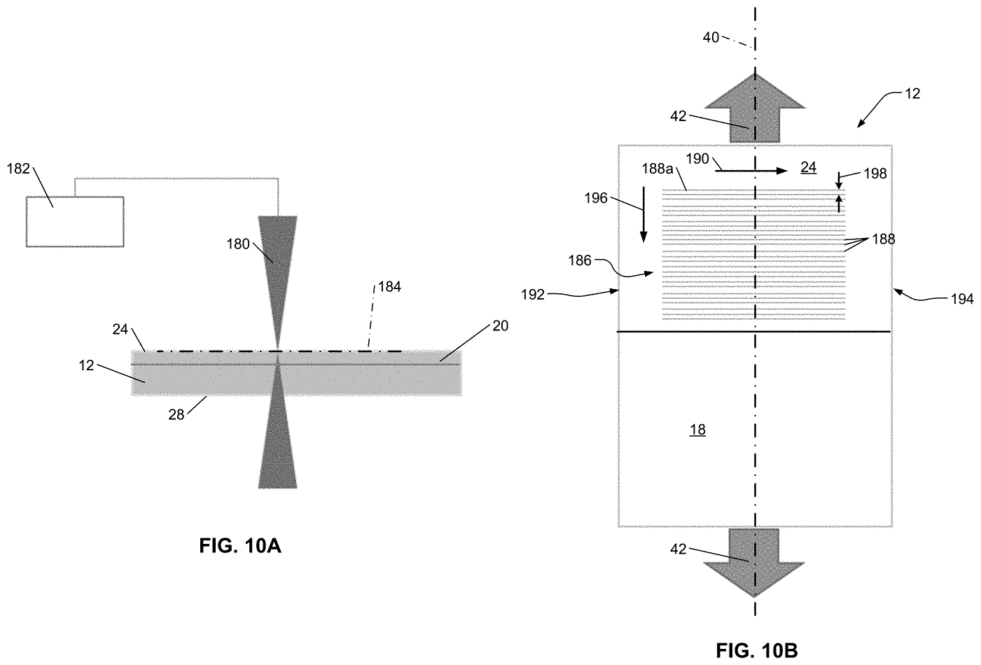

With reference to FIGS. 6-7, the metal component 12 may initially include a sacrificial coating 140 that may be removed from the metal component 12 prior to adding the layer 20 to the first surface 18. For example, the metal component 12 may be hot-dip galvanized steel (HDG steel). HDG steel includes a zinc coating. Because zinc has a relatively low melting point, it may be partially vaporized and trapped within molten portions to create undesirable bubbles and pores during the subsequent laser surface treatment (discussed in greater detail below with respect to FIGS. 10A-12). Accordingly, at least a portion of the sacrificial coating 140, such as on the portion 22 of the metal component 12, may be removed from the metal component 12.

The sacrificial coating 140 may be removed from the metal component 12 by directing a coating removal laser beam 142 from a first laser source 144 at a sixth surface 146 of the sacrificial coating 140. The first surface 18 of the metal component 12 is exposed as the sacrificial coating 140 is removed. A first focal plane 148 of the coating removal laser beam 142 may be aligned at the sixth surface 146. The coating removal laser beam 142 may be focused toward the sixth surface 146 to achieve the highest laser fluence possible in light of the other laser-treatment parameters. The coating removal laser beam 142 may be a nanosecond pulsed laser beam. The coating removal laser beam 142 may move relative to the metal component 12, the metal component 12 may move relative to the coating removal laser beam 142, or both the metal component 12 and the coating removal laser beam 142 may move relative to one another.

The coating removal laser beam 142 may have a pulse width of greater than or equal to about 9 ns to less than or equal to about 200 ns, optionally greater than or equal to about 50 ns to less than or equal to about 200 ns, optionally greater than or equal to about 100 ns to less than or equal to about 200 ns, and optionally about 200 ns. The coating removal laser beam 142 may have a pulse overlap of greater than or equal to about 0% to less than or equal to about 50%, optionally greater than or equal to about 5% to less than or equal to about 45%, optionally greater than or equal to about 10% to less than or equal to about 40%, and optionally about 35%. The coating removal laser beam 142 may have a repetition rate of greater than or equal to about 10 kHz to less than or equal to about 500 kHz, optionally greater than or equal to about 100 kHz to less than or equal to about 400 kHz, optionally greater than or equal to about 150 kHz to less than or equal to about 300 kHz, and optionally about 200 kHz.

The coating removal laser beam 142 may create a spot size of greater than or equal to about 10 μm to less than or equal to about 100 μm, optionally greater than or equal to about 30 μm to less than or equal to about 80 μm, optionally greater than or equal to about 50 μm to less than or equal to about 70 μm, and optionally about 67 μm. The coating removal laser beam 142 may have a scan speed of greater than or equal to about 100 mm/s to less than or equal to about 10 m/s, optionally greater than or equal to about 200 mm/s to less than or equal to about 2 m/s, optionally greater than or equal to about 300 mm/s and less than or equal to about 1 m/s, and optionally about 500 mm/s. The coating removal laser beam 142 may have a scan power of greater than or equal to about 50 W to less than or equal to about 500 W, optionally greater than or equal to about 100 W to less than or equal to about 400 W, optionally greater than or equal to about 200 W to less than or equal to about 300 W, and optionally about 270 W.

Although the method 120 is described with reference to the assembly 10 of FIGS. 1A-2B, additional or different steps may be performed to create different metal-polymeric composite assemblies. For example, a depression (e.g., depression 78 of assembly 70 of FIG. 3) may optionally be formed in the metal component 12. The depression may be formed by the coating removal laser beam 142 concurrently with removing the sacrificial coating 140. In another example, the depression can be formed by mechanical methods before or after step 122.

In various alternative embodiments, the coating 140 may be removed by other methods. In one example, the coating 140 is removed by mechanical means, such as by milling or grinding. The sacrificial coating removal step (i.e., step 122) is optional; it may be unnecessary, for example, when the metal component 12 is provided without a sacrificial coating (e.g., when the first metallic composition is cold-rolled steel).

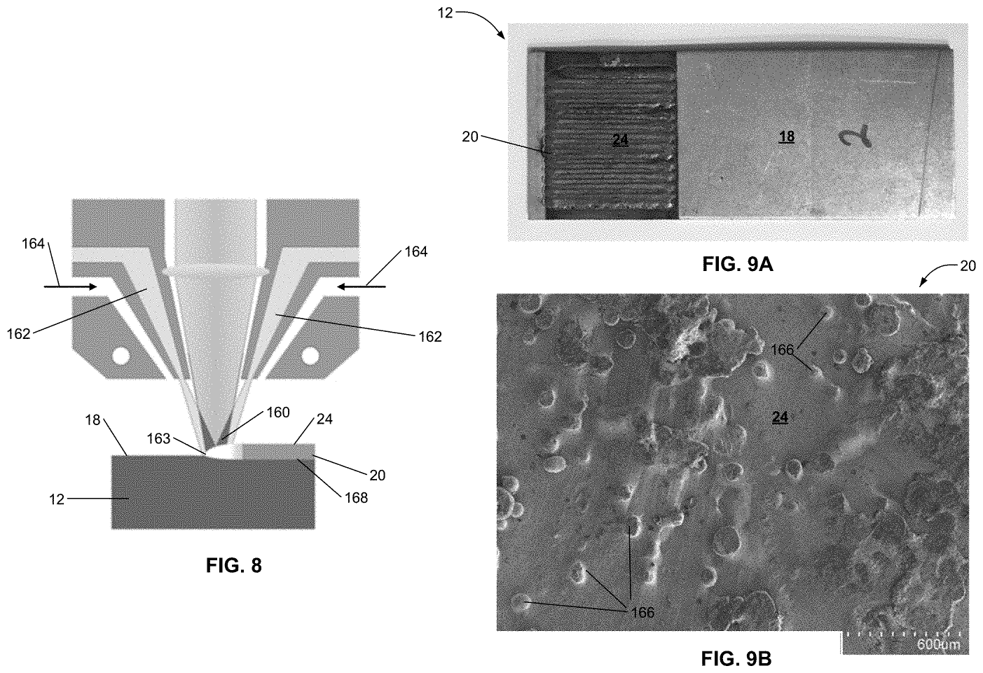

### Laser Cladding (FIGS. 8-9B)

Referring to FIGS. 8-9B, the layer 20 may be deposited on the first surface 18 of the metal component 12 by laser cladding. A cladding laser beam 160 from a second laser source (not shown) may be directed at the first surface 18. A precursor 162 may be directed toward an intersection 163 of the cladding laser beam 160 and the first surface 18. The precursor 162 may include the second metallic composition. In various aspects, the precursor 162 may include one or more powder streams. In alternative aspects, the precursor 162 may include a wire feedstock (not shown). The cladding laser beam 160 melts at least a portion of the second metallic composition of the precursor 162 and at least a portion of the first metallic composition of the metal component 12 to weld the layer 20 to the metal component 12. In various aspects, the precursor 162 may be deposited in streams that are substantially coaxial with the cladding laser beam 160. A shielding gas 164, such as argon, may also be directed at the intersection.

An average diameter of the powder particles of the precursor 162 may be greater than or equal to about 10 μm to less than or equal to about 500 μm, optionally greater than or equal to about 20 μm to less than or equal to about 400 μm, optionally greater than or equal to about 30 μm to less than or equal to about 300 μm, and optionally greater than or equal to about 40 μm to less than or equal to about 200 μm. The particle size (e.g., diameter) and size distribution may be selected based on the desired characteristics of the layer 20. For example, larger particles may result in the layer 20 being thicker. The layer 20 may be deposited by a single pass of the cladding laser beam 160, or multiple passes of the cladding laser beam 160 of the first surface 18 of the metal component 12. Each pass of the laser beam 160 may deposit a thickness of about 0.25 millimeters

As shown in FIG. 9B, the second surface 24 of the layer 20 may include a rough or irregular topography, including the plurality of protrusions 166. The layer 20 may be substantially free of apertures, pinholes, or bubbles. That is, the layer 20 may be continuous over the portion 22 (FIG. 1A) of the first surface 18.

The laser cladding process of step 124 may result in a high fusion bond between the second metallic composition of a layer 20 and the first metallic composition of the metal component 12. The high fusion bond can result in a stronger connection between the first and second metallic compositions than is possible with physical or chemical joining processes such as thermal/cold spray or electroplating deposition. Accordingly, after the joint 19 (FIG. 1A) is formed, failure of the joint 19 is unlikely to occur at an interface 168 of the first metallic composition of the metal component 12 and the second metallic composition of the layer 20.

The cladding laser beam 160 may be a continuous wave (CW) laser beam. The cladding laser beam 160 may have a power of greater than or equal to about 500 W to less than or equal to about 3,000 W, optionally greater than or equal to about 1,000 watts to less than or equal to about 2,500 W, optionally greater than or equal to about 1,200 watts to less than or equal to about 2,000 W, and optionally about 1,500 watts. The cladding laser beam 160 may have beam size of greater than or equal to about 1 mm to less than or equal to about 10 mm, optionally greater than or equal to about 2 mm to less than or equal to about 7 mm, optionally, greater than or equal to about 3 mm to less than or equal to about 5 mm, and optionally about 4 mm. the cladding laser beam 160 may move with respect to the metal component 12, the metal component 12 may move with respect to the cladding laser beam 160, or the cladding laser beam 160 and the metal component 12 a move with respect to one another at a travel speed. The travel speed may be greater than or equal to about 5 mm/s to less than or equal to about 80 mm/s, optionally greater than or equal to about 10 mm/s to less than or equal to about 60 mm/s, optionally, greater than or equal to about 20 mm/s to less than or equal to about 40 mm/s, and optionally about 30 mm/s.

### Laser Surface Treatment (FIGS. 10A-11B)

With reference to FIGS. 10A-11B, the elongate peaks 34, elongate valleys 36, crests 50, and troughs 52 (including the micro-anchors 54) may be formed on the second surface 24 by a laser surface treatment at step 126. The laser surface treatment may be referred to as a surface ablation process. The laser surface treatment may include directing a surface treatment laser beam 180 from a third laser source 182 at the second surface 24. The surface treatment laser beam 180 may move relative to the metal component 12 to create the plurality of elongate valleys 36. The elongate peaks 34 may be defined on areas of the second surface 24 adjacent to the elongate valleys 36. As the elongate valleys 36 are created by moving the surface treatment laser beam 180 over the second surface 24, the surface treatment laser beam 180 may heat the second surface 24, thereby liquefying and/or vaporizing a portion of the second metallic composition at the second surface 24 of the layer 20.

The surface treatment laser beam 180 may be a nanosecond pulsed laser. During a laser pulse, the surface treatment laser beam 180 may melt a portion of the second metallic material of the layer 20. The liquefied metal may cool and solidify during a time between laser beam pulses. The relatively-short nanosecond pulse may lead to a dynamic heating and cooling process so that the molten metal solidifies before it can reach equilibrium and settle to form a smooth surface. Such a dynamic heating and cooling process may facilitate the formation of a specialized rough or irregular topography on the second surface 24 of the layer 20 of the metal component 12. More particularly, the micro-anchors 54 may be formed after liquefied metal rises to define a crest 50 that then collapses back toward the second surface 24. Accordingly, the laser surface treatment of step 126 can facilitate the formation of the troughs 52 and crests 50, some of which define micro-anchors 54 and micro-apertures 56.

A second focal plane 184 of the surface treatment laser beam 180 may be aligned at the second surface 24. The surface treatment laser beam 180 may be focused toward the second surface 24 to achieve the highest laser fluence possible in light of the other laser-treatment parameters. The surface treatment laser beam 180 may have a pulse width of greater than or equal to about 9 ns to less than or equal to about 200 ns, optionally greater than or equal to about 50 ns to less than or equal to about 200 ns, optionally greater than or equal to about 100 ns to less than or equal to about 200 ns, and optionally about 200 ns. The surface treatment laser beam 180 may have a pulse overlap of greater than or equal to about 0% to less than or equal to about 50%, optionally greater than or equal to about 5% to less than or equal to about 45%, optionally greater than or equal to about 10% to less than or equal to about 40%, and optionally about 35%. The surface treatment laser beam 180 may have a repetition rate of greater than or equal to about 10 kHz to less than or equal to about 500 kHz, optionally greater than or equal to about 100 kHz to less than or equal to about 400 kHz, optionally greater than or equal to about 150 kHz to less than or equal to about 300 kHz, and optionally about 200 kHz.

At least one of the surface treatment laser beam 180 and the metal component 12 may move with respect to the other of the surface treatment laser beam 180 and the metal component 12 to create a first laser pattern 186, as best shown in FIG. 10B. For example, a laser head may move the surface treatment laser beam 180 while the metal component 12 remains stationary. In another example, the metal component 12 may move while the laser head remains stationary.

The first laser pattern 186 may include a plurality of parallel lines 188, for example, to create the plurality of elongate valleys 36. The surface treatment laser beam 180 may be moved in a first direction 190 from a first end 192 of the layer 20 to a second end 194 of the layer 20 to create a first line 188a. The laser head may then return to the first end 192 and move in a second direction 196 substantially perpendicular to the first direction 190 to a starting position to create another line 188 adjacent to the first line 188a. The process may be repeated to create the first laser pattern 186.

The lines 188 of the first laser pattern 186 may be disposed substantially perpendicular to the second axis 40, which is aligned with a direction of the applied force 42. The surface treatment laser beam 180 may create a spot size of greater than or equal to about 10 μm to less than or equal to about 100 μm, optionally greater than or equal to about 30 μm to less than or equal to about 80 μm, optionally greater than or equal to about 50 μm to less than or equal to about 70 μm, and optionally about 67 μm. A first distance 198 between lines 188 may desirably be less than the spot size to ensure that the entire joining region 16 includes the crests 50, the troughs 52, and the micro-anchors 54. For example, when the spot size is about 67 mm, the first distance 198 between the lines 188 may be greater than or equal to about 20 μm to less than or equal to about 60 μm, optionally greater than or equal to about 25 μm to less than or equal to about 50 μm, and optionally about 50 μm. The surface treatment laser beam 180 may have a scan speed of greater than or equal to about 100 mm/s to less than or equal to about 10 m/s, optionally greater than or equal to about 200 mm/s to less than or equal to about 2 m/s, optionally greater than or equal to about 300 mm/s and less than or equal to about 1 m/s, and optionally about 500 mm/s. The surface treatment laser beam 180 may have a scan power of greater than or equal to about 50 W to less than or equal to about 500 W, optionally greater than or equal to about 00 W to less than or equal to about 400 W, optionally greater than or equal to about 200 W to less than or equal to about 300 W, and optionally about 270 W.

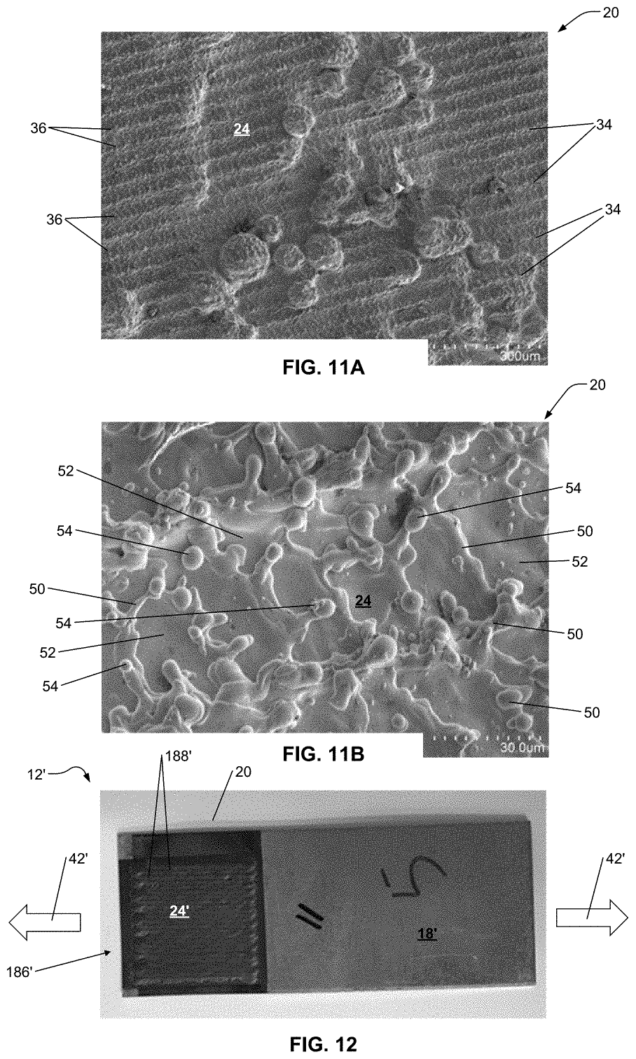

Although the lines 188 are shown and described as extending substantially perpendicular to the direction of applied force 42, other orientations are contemplated. With reference to FIG. 12, another metal component 12′ according to certain aspects of the present disclosure is provided. The metal component 12′ includes a first surface 18′ and having a layer 20′ disposed thereon. The layer 20′ include a second surface 24′. The first laser pattern 186′ is defined in the second surface 24′. The first laser pattern 186′ includes the plurality of parallel lines 188′. Each line 188′ extends substantially parallel to a direction of applied force 42′.

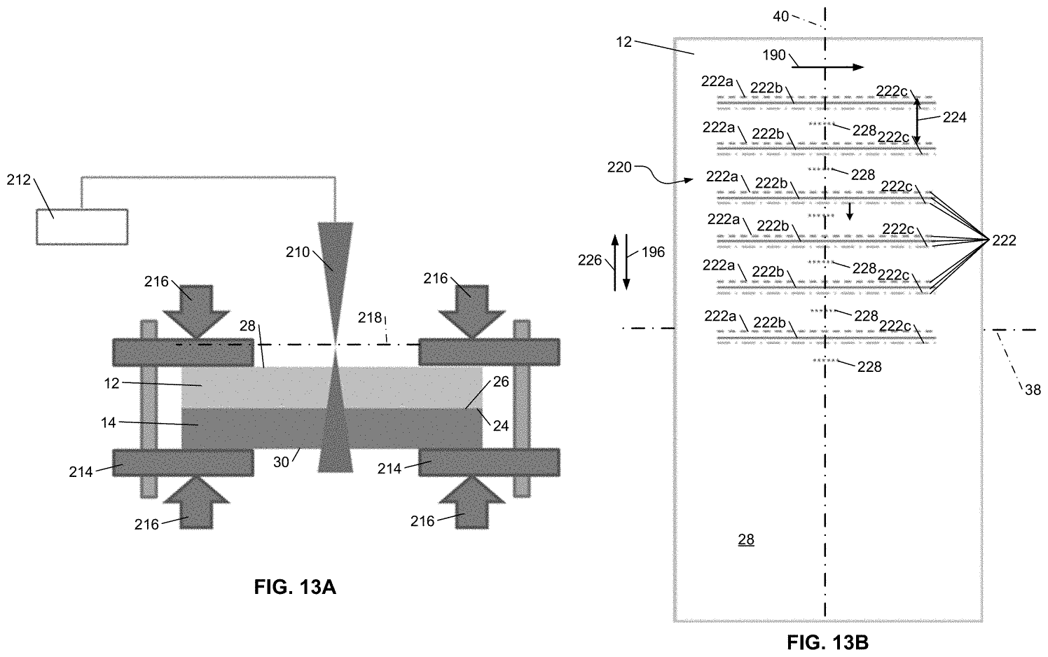

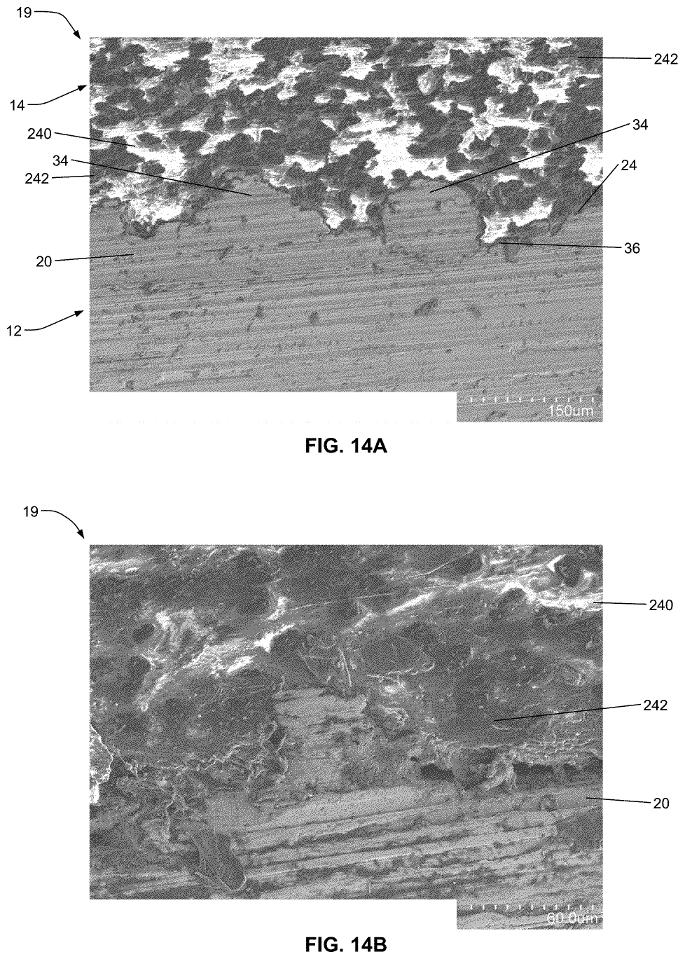

### Laser Joining (FIGS. 13A-14B)

At step 128, the metal component 12 may be joined to the composite component 14. Generally, the joining process may include melting a portion of the polymer at the third surface 26 of the composite component 14 so that the molten polymer flows in and around the micro-anchors 54. When the application of heat ceases, the polymer cools and solidifies to couple the composite component 14 to the metal component 12. Referring to FIGS. 13A-13B, a heat source for the joining may be a joining laser beam 210 from a fourth laser source 212. However, those skilled in the art would appreciate that the heating may additionally or alternatively include other heat sources, such as exposure to a torch, induction heating, ultrasonic welding, or combinations thereof by way of example.

The joining may include contacting the second surface 24 of the metal component 12 with the third surface 26 of the composite component 14, as shown in FIG. 13A. The metal component 12 may be disposed on top of the composite component 14. The components 12, 14 may overlap partially (i.e., at the joining region 16) or fully (i.e., over an area larger than the joining region 16). The second surface 24 of the layer 20 may be disposed toward the third surface 26 of the composite component 14. The second surface 24 may directly contact the third surface 26. The components 12, 14 may both be disposed within clamps 214. A force 216 may be applied at the clamps 214 to maintain contact between the components 12, 14.

Joining the components 12, 14 may include directing the joining laser beam 210 towards the fourth surface 28 while the second and third surfaces 24, 26 are in contact. The joining laser beam 210 may be a continuous wave (CW) laser beam. A third focal plane 218 of the joining laser beam 210 may be aligned above the fourth surface 28, as shown in FIG. 13A, or alternatively below the fourth surface 28 (not shown). Thus, unlike the second focal plane 184 the laser surface treatment of step 126, the third focal plane 218 is not aligned with the fourth surface 28. Instead, the joining laser beam 210 may be defocused at the fourth surface 28. Defocusing the joining laser beam 210 minimizes damage to the metal component 12 due to overheating and material vaporization. The joining laser beam 210 may be defocused within a range of greater than or equal to about −3 mm to less than or equal to about +3 mm.

Due to the first and second metallic compositions of the metal component 12 having high conductivity, heat may be transferred from the fourth surface 28, through the metal component 12, to the cooler second surface 24. Heat at the second surface 24 of the metal component 12 may heat the third surface 26 of the composite component 14 to melt at least a portion of the polymer of the composite component 14. A first melting temperature of the first metallic composition and a second melting temperature of the second metallic composition may both be greater than a third melting temperature of the polymer of the composite component 14. For example, the first metallic composition may include low carbon steel having a melting temperature of about 1,300° C., the second metallic composition may include SS316 stainless steel having a melting temperature of about 1,400° C., and the composite component 14 may include nylon having a melting temperature of about 250° C.

A temperature of the second surface 24 of the metal component 12 may remain below the second melting temperature during the application of the joining laser beam 210 so that the metal component 12 remains in a solid state near the joint 19. The temperature of the metal component 12 may remain below the second melting temperature to minimize or prevent damage to the layer 20 of the metal component 12. A temperature of the composite component 14 at the third surface 26 may be greater than or equal to the third melting temperature so that a portion of the polymer of the composite component 14 melts and flows into the micro-anchors 54 (FIGS. 2A-2B). The polymer may cool and solidify when the application of heat from the joining laser beam 210 ceases.

A temperature in the joining region 16 may be greater than the third melting temperature and less than the second melting temperature. For example, the temperature in the joining region 16 may be greater than or equal to about 1,000° C. to less than or equal to about 2,500° C. In some examples, a temperature of the fourth surface 28 of the metal component may be greater than the first melting temperature, resulting the fourth surface 28 being at least partially liquefied during the heating process.

The joining laser beam 210 may move relative to the components 12, 14 to create a second laser pattern 220. For example, the laser head may move the joining laser beam 210 while the components 12, 14 remain stationary. In another example, the components 12, 14 may move while the laser head remains stationary. The second laser pattern 220 may include a plurality of parallel lines 222. As discussed above, it may be desirable to avoid overheating the metal component 12. Thus, the second laser pattern 220 may be different than the first laser pattern 186 of the laser surface treatment of step 126. In one example, the second laser pattern 220 may include two or more subsets of lines 222, such as a first subset 222a, a second subset 222b, a third subset 222c, and so on. The laser head may move in the first direction 190 to create a first line of the first subset 222a. The laser head may then move in the second direction 196 and then in the first direction 190 to create another line 222a in the same subset. A second distance 224 between lines of the same subset may be greater than or equal to about 0.5 mm to less than or equal to about 5 mm. After the joining laser beam 210 has completed the first scan set (e.g., moved through all of the lines 222a of the first subset), it may move in a third direction 226 opposite the second direction 196 to begin a second scan set. After the joining laser beam 210 has completed the second scan set (e.g., moved through all of the lines 222b of the second subset), it may move in the third direction 226 to begin a third scan set. The above process may be repeated until the second laser pattern 220 is complete. As shown in FIG. 13B, ellipses 228 in the second laser pattern 220 represent additional scan groups (e.g., to create a fourth subset and a fifth subset). In certain variations, the lines 222 of the second laser pattern 220 may be evenly spaced apart from one another. It may be desirable that the lines 222 do not overlap or cross one another to avoid overheating.

Although the second laser pattern 220 is shown as substantially aligned with the first axis 38 and substantially perpendicular to the second axis 40, alternative laser patterns are contemplated. Because the joining laser beam 210 is used to heat the components 12, 14 rather than to form a particular topography, the orientation of the second laser pattern 220 may be varied. In various alternative aspects, the second laser pattern 220 may be aligned with the second axis 40 (not shown). In other alternative aspects, the second laser pattern 220 may not be aligned with either axis 38, 40 (not shown). Those skilled in the art would appreciate that any laser pattern that does not overheat and damage the metal component 12 may be employed to join the metal component 12 to the composite component 14.

The joining laser beam 210 may have a power of greater than or equal to about 500 W to less than or equal to about 3,000 W, optionally greater than or equal to about 800 W to less than or equal to about 2,500 W, optionally greater than or equal to about 1,200 W to less than or equal to about 2,000 W, and optionally about 1,800 W. The joining laser beam 210 may have a scan speed of greater than or equal to about 100 mm/s to less than or equal to about 2 m/s, optionally greater than or equal to about 300 mm/s to less than or equal to about 1.5 m/s, optionally greater than or equal to about 500 mm/s to less than or equal to about 1 m/s, and optionally about 750 mm/s. The joining laser beam 210 may create a spot size of greater than or equal to about 100 μm to less than or equal to about 500 μm, optionally greater than or equal to about 120 μm to less than or equal to about 300 μm, optionally greater than or equal to about 150 μm to less than or equal to about 200 μm, and optionally about 180 μm.

With reference to FIGS. 14A-14B, the joint 19 formed by the method 120 according to certain aspects of the present disclosure is provided. The joint 19 may include the metal component 12 and the composite component 14. The composite component 14 may include a polymeric material 240 and a plurality of reinforcing fibers 242. The polymeric material 240 may include polyamide (PA, nylon) and the reinforcing fibers 242 may include carbon fibers. The second surface 24 of the layer 20 of the metal component 12 may include the elongate peaks 34 and the elongate valleys 36. In various aspects, the elongate peaks 34 and elongate valleys 36 define a periodic texture at the second surface 24. The polymeric material 240 at the third surface 26 of the composite component 14 may be in intimate contact with the second surface 24 of the metal component 12. Accordingly, in various aspects, the joint 19 may be free of any interfacial delamination.

The polymeric material 240 may at least partially occupy at least a portion of the micro-anchors 54. In certain variations, the polymeric material 240 may fully occupy at least a portion of the micro-anchors 54. In certain variations, the polymeric material 240 may fully occupy all of the micro-anchors 54. The polymeric material 240 may be intertwined with the second metallic composition of the layer 20. For example, the polymeric material 240 may occupy the micro-anchors 54 to form hooks or loops around the micro-anchors 54. The polymer hooks or loops can mechanically interact with the micro-anchors 54 to form a strong joint. In certain variations, the joint 19 may behave like a hook-and-loop fastener; however, unlike a typical hook-and-loop fastener, the joint 22 is permanent so that the metal component 12 cannot be readily peeled away from the composite component 14.

### Dielectric Coating

At step 130, a coating (see, e.g., coating 106 of FIG. 4) may optionally be applied to the metal-polymeric composite assembly 10 to fully enclose the metal component 12 and the composite component 14. In one example, the coating is applied in a vehicle painting process using a water-based polyurethane enamel paint. In another example, the coating is applied by spray painting, dip coating, electrodeposition, and/or paint brushing. The coating may create a fluid seal around the entire metal-polymeric composite assembly 10 to prevent completion of a galvanic circuit at the joint 19, such as by preventing the ingress of moisture or another electrolyte.

### Laser Surface Treatment Patterns

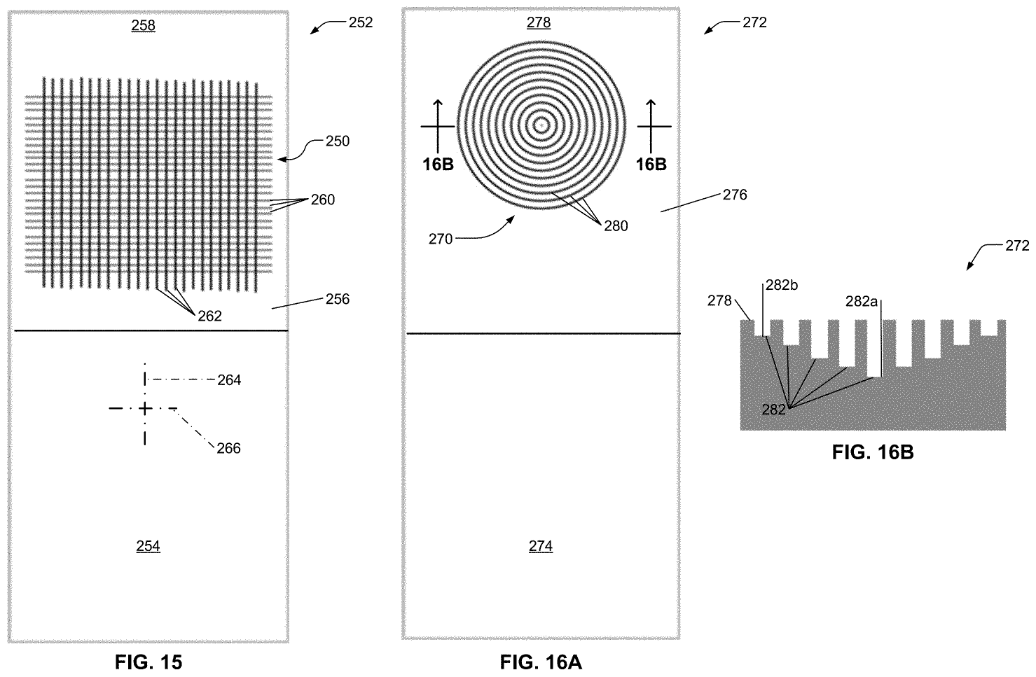

Referring to FIG. 15, an alternative laser pattern 250 for the laser surface treatment (i.e., step 126) according to certain aspects of the present disclosure is provided. A metal component 252 includes a first surface 254 having a layer 256 disposed thereon. The layer 256 includes a second surface 258 defining the laser pattern 250. The laser pattern 250 includes a first plurality of parallel lines 260 and a second plurality of parallel lines 262. The lines of the first plurality 260 may extend substantially perpendicular to the lines of the second plurality 262. Thus, when the metal component 252 is joined to a composite component, the resulting joint has a high lap shear strength along a first axis 264 and a second axis 266 substantially perpendicular to the first axis.

With reference to FIGS. 16A-16B, another alternative laser pattern 270 for the laser surface treatment (i.e., step 126) according to certain aspects of the present disclosure is provided. A metal component 272 may include a first surface 274 having a layer 276 disposed thereon. The layer 276 may include a second surface 278 defining the laser pattern 270. The laser pattern 270 may include a plurality of concentric circles 280. Thus, when the metal component 272 is joined to a composite component, the resulting joint has a 360° high lap shear strength.

In various aspects, the concentric circles 280 of the laser pattern 270 may yield grooves 282 having different depths. For example, grooves 282a near a center of the concentric circles 280 may be deeper than outermost grooves 282b. The depth of a groove can be controlled by applying different laser power to create grooves having different depths (i.e., a higher power to create a deeper groove and a lower power to create a shallower groove) or applying different quantities of scans/passes for different grooves (i.e., more scans to create a deeper groove and fewer scans or a single scan to create a shallower groove).

### EXAMPLE 1

### 7-Day Corrosion Testing

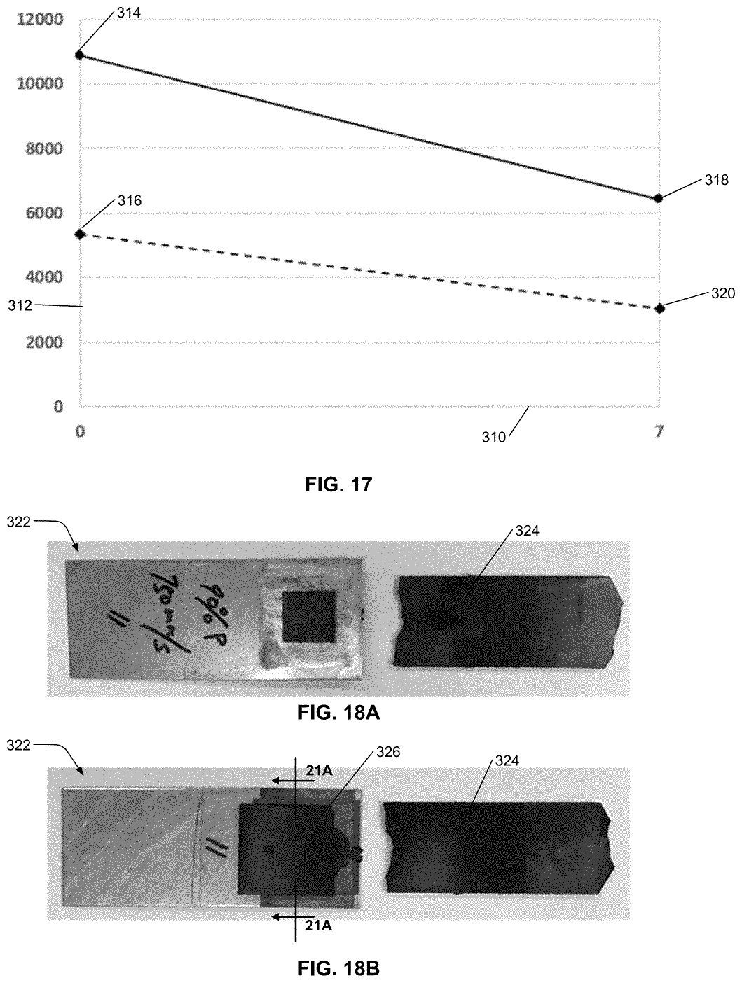

With reference to FIGS. 17-19B, a first, second, third, and fourth metal-polymeric composite assemblies (also referred to as first, second, third, and fourth samples) are prepared according to certain aspects of the present disclosure. The first and third samples each include a first component having a first surface with a layer disposed thereon. A body of the first component includes a first metallic composition and the layer includes a second metallic composition. The first metallic composition includes hot dip galvanized (HDG) low-carbon steel and the second metallic composition includes SS316 stainless steel. The second and fourth samples each include a first component having the first metallic composition and a sacrificial coating including zinc (e.g., HDG steel). The second and fourth samples do not have layers of the second metallic material. Each of the first, second, third, and fourth components includes a second component including a polymer and a plurality of reinforcing fibers. The polymer includes Nylon 6 and the reinforcing fibers include carbon fibers.

Lap shear testing is performed to determine an initial lap shear strength of the first and second samples. Referring to FIG. 17, an x-axis 310 represents duration in days and a y-axis 312 represents lap shear strength in newtons (N). A first point 314 represents the initial lap shear strength of the first sample. The initial lap shear strength of the first sample is 10,880 N. A second point 316 represents the initial lap shear strength of the second sample. The initial lap shear strength of the second sample is 5,538 N. Thus, initial lap shear strength for the first component including the layer is higher than the initial lap shear strength for the second component omitting the layer.

The third and fourth samples are soaked in water at 54° C. for 7 days. Upon being removed from the water, the third and fourth samples are subjected to lap shear testing. A third point 318 represents the lap shear strength of the third sample after 7-days. The lap shear strength after 7 days is 6,410 N, a 41% degradation from the initial lap shear strength of the first sample. The lap shear strength after 7 days therefore exceeds 6,000 N. A fourth point 320 represents the lap shear strength of the fourth sample after 7-days. The lap shear strength after 7 days is 3,046 N, a 45% degradation from the initial lap shear strength of the second sample. Thus, the degradation of lap shear strength is lower for the third component including the layer.

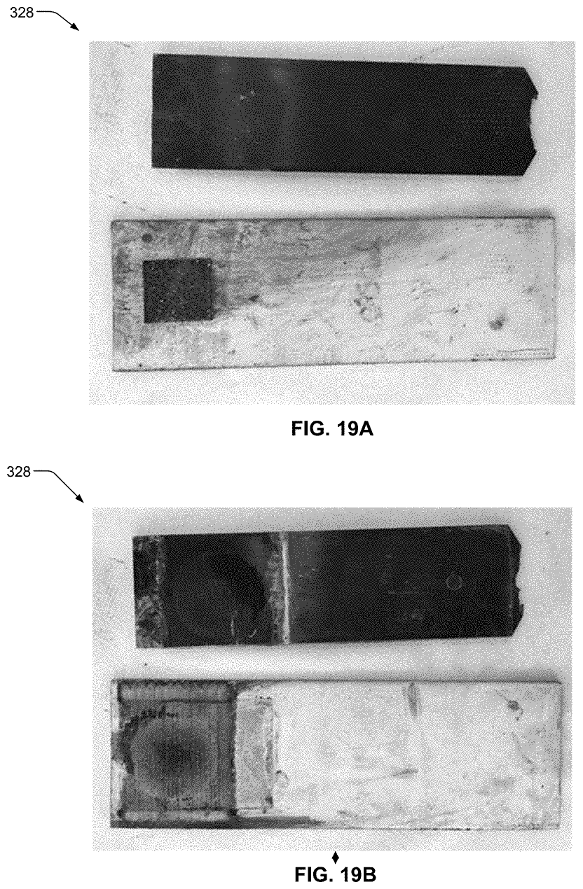

With reference to FIGS. 18A-18B, the first sample 322 after lap shear testing is shown. The first sample 322 failed at a composite component 324 rather than at a joint 236. With reference to FIGS. 19A-19B, the third sample 328 after lap shear testing is shown. The third sample 328 failed at a joint.

### EXAMPLE 2

### Cyclic Corrosion Testing

First and second sets of samples are prepared. Each of the samples of the first set includes a metal component including steel and a stainless steel 316 layer, and a composite component including Nylon 6 and carbon fibers. Each of the samples of the second set includes a metal component including steel having a sacrificial zinc coating (e.g., HDG steel), and a composite component including Nylon 6 and carbon fibers.

The samples undergo cycles of a salt spray and dry off. Each test cycle includes three stages: (1) an ambient stage at a first temperature of about 25° C.±3° C. and a first relative humidity of about 45%±10%; (2) a humid stage at a second temperature of about 49° C.±2° C. and a second relative humidity of about 10%; and (3) a dry-off stage at a third temperature of about 60° C.±2° C. and a third relative humidity of less than about 30%. Each stage is performed for a duration of about 8 hours, for a total cycle duration of about 24 hours.

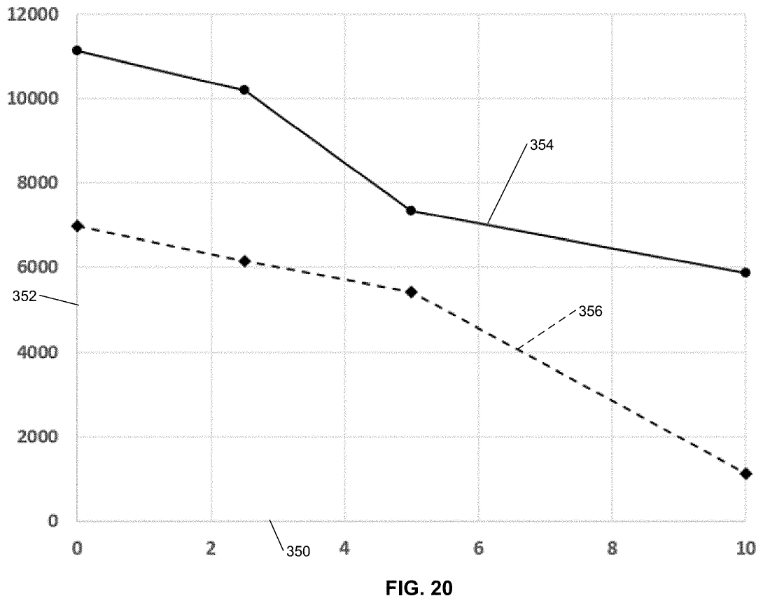

With reference to FIG. 20, a plot showing expected degradation of various joints over ten years is provided. An x-axis 350 represents duration in years and a y-axis 352 represents lap shear strength in newtons (N). A first curve 354 represents lap shear strength of the first set of components. A second curve 356 represents lap shear strength of the second set of components. The first set of components has an initial lap shear strength of 11,110 N, a 2.5-year lap shear strength of 10,195 N, a 5-year lap shear strength of 7,341 N, and a 10-year lap shear strength of 5,878 N. The second set of components has an initial lap shear strength of 6,970 N, a 2.5-year lap shear strength of 6,152 N, a 5-year lap shear strength of 5,427 N, and a 10-year lap shear strength of 1,131 N. Thus, the second set of samples omitting the layer may experience significantly more degradation in lap shear strength over a 10-year time period.

### EXAMPLE 3

### Layer Analysis

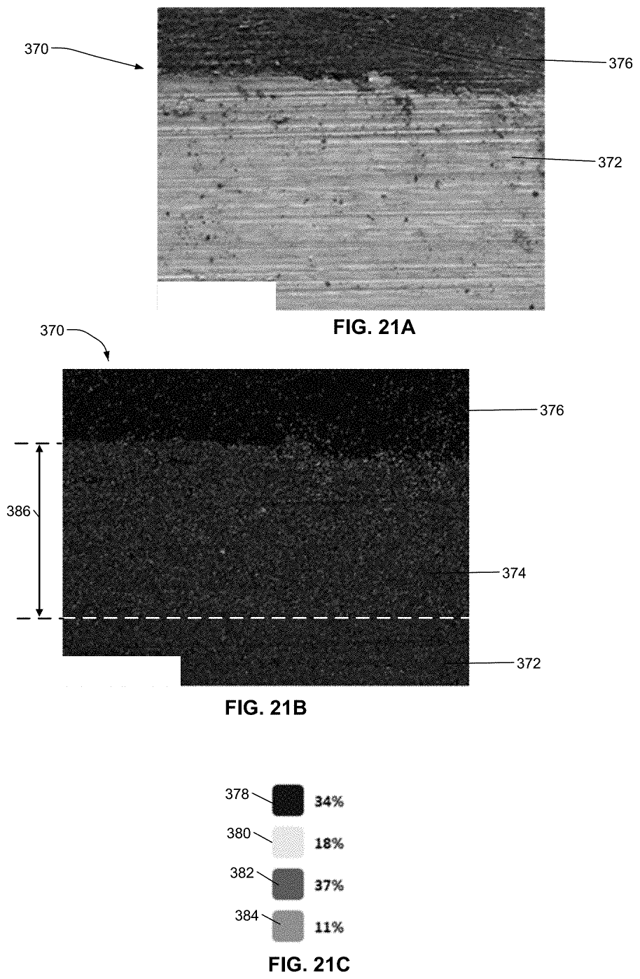

With reference to FIGS. 21A-21C, the composition of a joint is analyzed. The joint 370 includes a metal component 372 including steel and a layer 374, and a composite component 376. Energy-dispersive X-ray spectroscopy (EDX), is used to determine a thickness of a layer 374. Referring to FIG. 21C, a first color 378 corresponds to carbon, a second color 380 corresponds to chromium, a third color 382 corresponds to iron, and a fourth color 384 corresponds to nickel. The percentages correspond to weight percent of each element. Element mapping, a composite of which is shown at FIG. 21B, is used to identify the layer 374. An average thickness 386 of the layer 374 is about 600 μm.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. The method of claim 11, further comprising forming the layer by:
melting a portion of the first metallic composition of the first component by directing a second laser beam toward the first surface of the first component;
depositing the second metallic composition on the first surface by directing a precursor comprising the second metallic composition toward an intersection of the first surface and the second laser beam, the second metallic composition being galvanically more noble than the first metallic composition; and
forming the layer on the first component by solidifying the first metallic composition and the second metallic composition.

2. (canceled)

3. The method of claim 11, wherein the layer defines a thickness of greater than or equal to about 10 μm.

4. The method of claim 1, wherein the precursor comprises a plurality of particles, at least a portion of the plurality of particles comprising the second metallic composition.

5. The method of claim 1, wherein the second laser beam is a continuous wave (CW) laser beam.

6. The method of claim 5, wherein:
the second laser beam has a power of greater than or equal to about 500 W to less than or equal to about 3,000 W;
the second laser beam has a travel speed of greater than or equal to about 5 mm/s to less than or equal to about 80 mm/s; and
the second laser beam has a beam size of greater than or equal to about 1 mm to less than or equal to about 10 mm.

7. (canceled)

8. The method of claim 1, further comprising removing at least a portion of a coating of the first component prior to the melting, the coating comprising zinc.

9. The method of claim 8, wherein the removing comprises directing a third laser beam comprising a nanosecond pulsed laser beam toward the first surface of the first component.

10. The method of claim 1, further comprising forming a depression in the first surface of the first component prior to the melting, wherein:
the melting comprises directing the first laser beam toward the depression; and
the depositing comprises directing the precursor toward the depression.

11. A method of forming a metal-polymeric composite joint, the method comprising:
disposing a first component comprising a layer on a second component, the first component including a body having a first surface, the layer being disposed across at least a portion of the first surface, the layer comprising a second surface, the second surface of the layer engaging a third surface of the second component, the body comprising a first metallic composition, the layer comprising a second metallic composition, and the second component comprising a polymer and a plurality of reinforcing fibers;
melting at least a portion of the polymer by directing a first laser beam from a laser head toward a fourth surface of the first component, the fourth surface being disposed opposite the second surface of the layer, the directing comprising,
(i) creating a first portion of a plurality of lines by moving the laser head with respect to the fourth surface, the laser head moving in a first direction between each line of the first portion of the plurality of lines,
(ii) after (i), moving the laser head in a second direction opposite the first direction, and
(iii) after (ii), creating a second portion of the plurality of lines non-overlapping with the first portion of the plurality of lines by moving the laser head with respect to the fourth surface, the laser head moving in the first direction between each line of the second portion of the plurality of lines, wherein a temperature of the layer remains below a melting point of the second metallic composition during the melting; and
forming the metal-polymeric composite joint by solidifying the polymer.

12. The method of claim 11, wherein the first laser beam comprises a continuous wave (CW) laser beam.

13. The method of claim 11, further comprising applying a dielectric coating to the first component and the second component after the forming.

14. The method of claim 11, wherein the first metallic composition comprises a steel and the second metallic composition comprises a stainless steel.

15. The method of claim 11, further comprising forming a plurality of micro-anchors on the second surface of the layer by directing a second laser beam comprising a nanosecond pulsed laser beam toward the second surface.

16. The method of claim 11, wherein:
the plurality of reinforcing fibers comprise carbon; and
the polymer is selected from the group consisting of: a polycarbonate (PC), a high-density polyethylene (HDPE), polyoxymethylene (POM), a thermoplastic elastomer (TPE), acrylonitrile butadiene styrene (ABS), a thermoplastic olefin (TPO), a polyamide (PA, nylon), and combinations thereof.

17-20. (canceled)

21. The method of claim 11, wherein the layer is disposed at least partially within a depression defined by the first surface.

22. The method of claim 11, wherein the layer defines a thickness of greater than or equal to about 100 μm.

23. The method of claim 11, wherein the second surface defines an average roughness of greater than or equal to about 30 μm to less than or equal to about 60 μm.

24. The method of claim 11, wherein:
the first laser beam has a power of greater than or equal to about 1,200 W to less than or equal to about 2,000 W;
wherein the first laser beam has a scan speed of greater than or equal to about 500 mm/s to less than or equal to about 1 m/s; and
wherein the first laser beam has a spot size of greater than or equal to about 150 μm to less than or equal to about 200 μm.

25. The method of claim 11, wherein each line of the first portion of the plurality of lines is spaced apart from adjacent lines of the first portion of the plurality of lines by a distance of greater than or equal to about 0.5 mm to less than or equal to about 5 mm.

26. The method of claim 11, wherein the melting further comprises,
(iv) after (iii), moving the laser head in the second direction, and
(v) after (iv), creating a third portion of the plurality of lines non-overlapping with the first portion of the plurality of lines and the second portion of the plurality of lines by moving the laser head with respect to the fourth surface, the laser head moving in the first direction between each line of the third portion of the plurality of lines.
